(19) United States
(12) Patent Application Publication
(10) Pub. No.: US 2014/0172612 A1
(43) Pub. Date: Jun. 19, 2014

(54) Method for the Offer and Sale of Products and/or Services at a Discounted Price

(71) Applicant: Riccardo Maggiolo, Vicenza (IT)

(72) Inventor: Riccardo Maggiolo, Vicenza (IT)

(21) Appl. No.: 13/720,137

(22) Filed: Dec. 19, 2012

(51) Int. Cl. G06Q 30/06

(52) U.S. Cl. CPC G06Q 30/0605
USPC 705/26.2

(57) ABSTRACT

A method for the offer and sale of one or more products and/or services with a discounted price associated with a minimum number of buyers. An expiry time is associated to the offer. The offer is opened with a starting price that is higher than the prearranged discounted price. Once the offer has been opened, users can subscribe to it through paying the discounted price. For every person subscribing to the offer, the price decreases by an amount that is proportional to the number of persons that subscribe to the offer until it reaches the prearranged discounted price. If the number of persons who subscribed the offer is equal to the prearranged minimum number of buyers the offer is dosed. If, at the end of the prearranged maximum amount of time of the offer, the number of persons who subscribed to the offer is lower than the prearranged minimum number of buyers, every person has a prearranged amount of time to pick and execute one of two options: —paying the difference between the price reached by the product or service at the end of the offer and the prearranged discounted price or —receiving a refund of an amount which is smaller than the prearranged discounted price.

### FIELD OF THE INVENTION

The invention relates to a method for offering and selling products and/or services, and more specifically a system and a method for offering products and/or services at a discounted price.

### BACKGROUND OF THE INVENTION

It is well-known that nowadays many internet websites offer e-commerce services, that is the retail sale of products and/or services of almost any kind and nature. Notoriously, this particular kind of websites are known as on-line shopping websites.

In particular, five different categories of on-line shopping websites can be identified.

A first category involves the so-called “store” websites, where products are offered for on-line sale at a fixed price. This kind of websites allows users to buy products without leaving their home, resulting in saving time and money.

However, disadvantageously, the products offered in this kind of websites do not have heavily-discounted prices compared to the ones that are associated to the same products in traditional shops.

A second category of on-line shopping websites, which can be called “auction” websites, tends to overcome the above-described disadvantage.

In this particular kind of websites every product is offered at a certain X price for a certain period of time. Every user interested in a product can make an offer rising the price of the product, for instance X+1.

Once the said period of time has expired, the user who made the highest offer will be allowed to buy the product.

However, disadvantageously, the user does not have much control over the success of his shopping activity. In fact, in order to secure the purchase of the product, the user has either to make an offer very close to the normal market price so as to discourage other users to raise it, or to hope that no one will raise his offer, even in the very last seconds before the expiring time. This is why in “auction” websites prices can either be very convenient or equal to the normal market price. In general, disadvantageously, the convenience of the ending price is related to the number of bids made in one auction. Thus, the more users are interested in the offer, the more they compete with one another and the more the price increases.

A third category of on-line shopping websites can be considered an extreme evolution of the just-mentioned second category. This third category of websites can be described as “bidding” websites; in this particular kind of websites the offer of the product at the beginning of its opening time is associated with an extremely discounted price, and the user has the possibility to raise the offer just of one monetary unit, for instance a real dollar-cent or a virtual one. Also in these websites there is an expiry time for every auction, but it is much shorter than the one of the above-described “auction” websites. Furthermore, this short period of time is increased by a certain quantity every time that a user raises the price with a new bid.

A further difference that distinguishes “bidding” websites from above-described “auction” websites is that the users who do not purchase the product lose some money for each of their bids. Because of this, disadvantageously, in addition to being encouraged to compete with one another, users can feel unsatisfied and frustrated if they do not manage to purchase the product they wish to buy.

A fourth category of on-line shopping websites can be described as “community” websites. These websites are based on consultation and comparison of products or services, and they are very similar to internet forums. The user, in fact, discusses and looks for information about a product or a service together with some other users. Then, users can decide whether to purchase or not a product or service, either together or on their own. In fact, these websites rely on the power of a friend's suggestion on a customer's choice to buy a product or service.

However, disadvantageously, there is no real link between the discussion about the product or service and the purchase action. This last one is considered more as an option, not necessarily to be executed on-line and, most of all, there is no certainty to obtain any discount on the normal market price. Because of this, the websites of this type can be considered as a sort of evolution of internet forums rather than proper on-line shopping websites.

The fifth and final category of on-line shopping websites tries to overcome the disadvantages of the above-mentioned categories of on-line shopping websites. These are the so called “group” or “tuangou” shopping websites.

In this particular kind of websites, users are not competing with one another but contrariwise, as will be detailed later, they have a common goal in purchasing a certain product or service at a discounted price.

In fact, each user logs-into the website and finds offers on products and services at heavily-discounted prices.

The user can subscribe an offer without being obliged to pay the discounted price straight away, as it will be cashed by the website just when the said offer has reached a prearranged minimum number of buyers.

However, the minimum number of buyers is not known by the user. Thus, even if the user invites and involves in any way other users in the subscription of the offer, this activity does not necessarily affect the price of the product or service offered. If the minimum number of buyers is reached or exceeded, the money transaction from the users who subscribed to the offer is automatically executed and cashed by the website. The above-mentioned users then receive either the product at home or a coupon to be presented at a shop or directly to the vendor in order to obtain the discounted-price product or service. However, disadvantageously, in this kind of websites sometimes the user is not satisfied with the quality of the purchased product or, more likely, service.

This is due to the fact that vendors are not really interested in keeping high-quality standards for the product or service they offer, because their profit would be rather small even if the sale is successful.

Thus, disadvantageously, the vendors involved in these kind of websites are more interested in promoting their product or service through the internet rather than selling it. That is why, in certain cases, some vendors accept to sell their product or service at a price that will not ensure them any profit at all, resulting in disappointment and frustration if the sale is not successful or does not achieve promotional goals.

On the contrary, if the prearranged minimum number of buyers is not reached by the expiration date of the offer, the user does not lose anything, because the money transaction is not executed. However, disadvantageously, the user who would like to purchase the product or service anyway is not allowed to do so, even at a higher price than the discounted one.

Furthermore the user, disadvantageously, does not have much control over the success of the sale of the product or the service he is interested in, being not very involved in the progress of the offer.

In fact, the user can invite other persons to get interested into the offer and eventually purchase the product or the service, but does not know how many buyers are needed to make the sale he is interested in, effective. Because of this, the user is not encouraged to involve other persons in the deal, not being able to clearly estimate his advantage in the operation.

### SUMMARY OF THE INVENTION

The present invention has the intention to overcome said drawbacks.

In particular, the invention's goal is to define and implement a method which will allow each of the following three subjects involved in an on-line shopping sale—the owner and/or the manager of the website or platform in which the method is applied, the vendor of the product or service and the user who purchases it—to obtain a profit or an advantage from the sale.

This goal is reached through the method of the invention which makes it possible to offer and sell products and/or services at a discounted price through group-buying.

More precisely, the method of the invention includes that each product and/or service being on sale is associated with a discounted price, and that this discounted price is associated with a minimum number of buyers.

An expiry time is associated to the offer.

The offer is opened with a starting price that is higher than the prearranged discounted price, and preferably but not necessarily equal to the normal market price. Once the offer has been opened, users interested in it can subscribe to it through paying the discounted price or a prearranged percentage of the starting price to the owner and/or the manager of the website, who cashes it straight away. For every person subscribing to the offer, the price decreases by an amount that is proportional to the number of persons that subscribe to the offer until, possibly but not necessarily, it reaches the prearranged discounted price.

During the entire opening time of the offer, every user or person can act in order to encourage other users or persons to subscribe to the offer.

If, at any time of opening of the offer, the number of persons who subscribed the offer is equal to the prearranged minimum number of buyers necessary to make the discounted price valid, the offer is closed. Then, all the persons who subscribed to the offer—possibly but not necessarily, after paying a delivery fee—receive either the product or an electronic proof of purchase—for instance, a coupon—which will allow them to obtain the purchased product or service from a shop or directly from the vendor.

If, at the end of the prearranged maximum amount of time of the offer, the number of persons who subscribed to the offer is lower than the prearranged minimum number of buyers necessary to make the discounted price valid, every person who subscribed to the said offer has a prearranged amount of time to pick and execute one of two options.

The first option is to purchase the product or the service by paying the difference between the price reached by the product or service at the end of the offer and the prearranged discounted price, which has already been paid.

The second option is to freely receive a refund of an amount which is smaller than the prearranged discounted price. Possibly but not necessarily, this refund is given as a credit to be used at any time on any other open offer that is or will be present on the website or platform that applies the method of the invention.

If the person does not pick any of the two options before the end of the prearranged amount of time, the owner and/or manager of the website owns the prearranged discounted price and the person who subscribed to the offer is neither able to purchase the product nor receive the refund.

Advantageously, the method of the invention encourages the collaboration among people interested in the offer, in order to allow them to reach a common advantage, that is, the purchase of a product and/or service at a discounted price if compared with the starting price.

More precisely, the method advantageously involves directly users and/or persons in the success of the sale of the product and/or service.

Furthermore, advantageously, the method of the invention allows users and/or persons to involve other users in the purchase of a product or a service.

More precisely, the method advantageously encourages the users to disclose, diffuse and make public the offer of the product and/or service and, together with it, the website or platform in which the method of the invention is applied.

### BRIEF DESCRIPTION OF THE DRAWING

The preferred embodiments of the invention will be described in conjunction with the appended drawing provided to illustrate and not to limit the scope of the invention, where like designations denote like elements, and in which:

FIG. 1 illustrates a flowchart in accordance with one embodiment of the invention.

### DETAILED DESCRIPTION OF THE PREFERRED EMBODIMENT

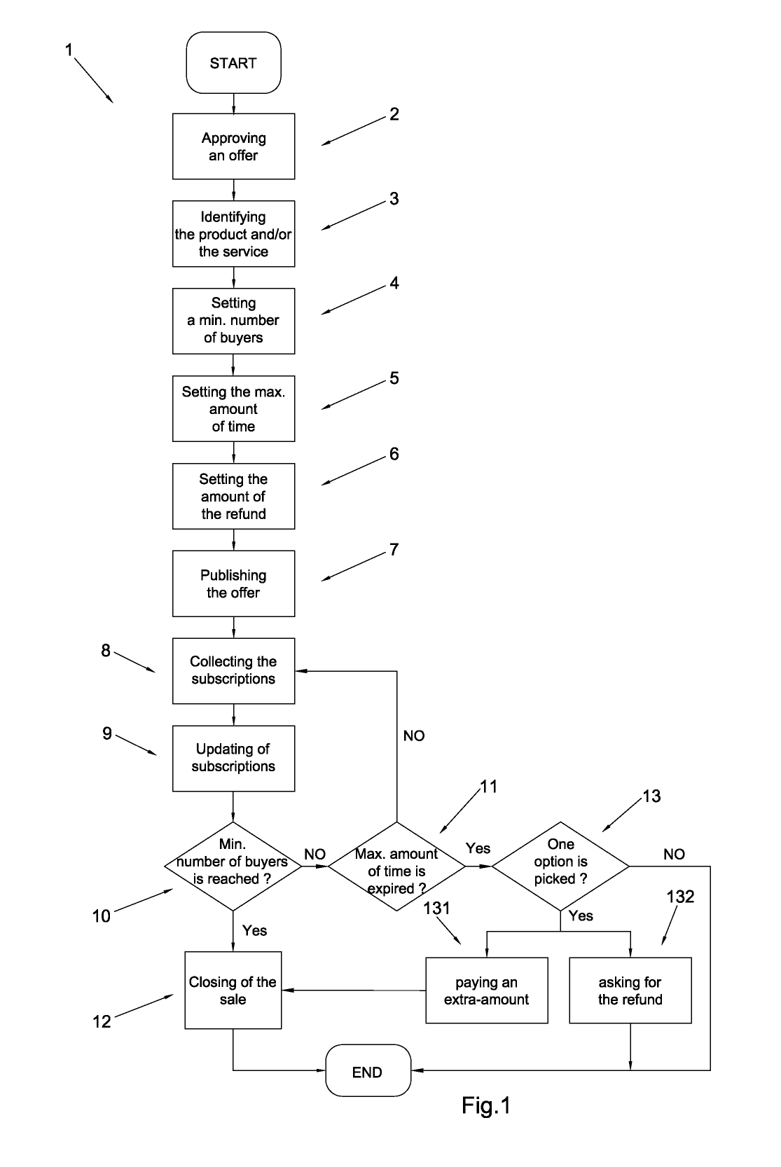

The method of the invention is illustrated in the flowchart 1 of FIG. 1, representing a preferred embodiment of the present invention.

As it can be noticed in FIG. 1, the first step 2 of the method includes the approval of the offer of sale of a product and/or a service made by a vendor, said offer having a predefined starting price.

Preferably, the approval of the offer includes a commercial negotiation between the vendor and the owner or/and the manager of the website or platform in which the method of the invention is applied.

Only if the negotiation is successful the vendor's offer is published in a way that will be described later.

Alternatively, the approval of the offer might include only the identification of the vendor through the use of a username and a password previously provided by the owner and/or the manager of the website or platform in which the method of the invention is applied. In this case, the conditions of the offer will be all set by the vendor respecting some limits imposed by the owner and/or the manager of the website or platform in which the method of the invention is applied.

Subsequently, the method of the invention includes step 3 of identification of the above-mentioned product or service offered on sale.

During this identification, a discounted price is set through the comparison with the starting price, that is, preferably but not necessarily equal to the normal market price related to the product and/or service in ordinary sale channels, such as shops.

Typically, the discounted price is calculated by reducing the above-mentioned starting price by a given percentage.

However, the discounted price could also be calculated by reducing the starting price by a fixed amount.

As detailed in FIG. 1, during the following step 4 a minimum number of buyers of the product and/or service is set. Once reached, said minimum number of buyers will make the sale valid for the prearranged discounted price.

Step 5 includes the definition of the maximum amount of time in which the offer of the above-mentioned product and/or service will be considered open.

Preferably, but not necessarily, this amount of time is no less than 24 hours. Typically, the amount of time in which the offer is considered open is of three days.

Furthermore, the invention includes step 6, which includes the definition of the amount of the refund to be offered to the users who subscribed to the offer of the above-mentioned product and/or service if the prearranged minimum number of buyers is not reached. The function and the goal of this refund will be explained later.

The following step 7 of the method of the invention includes the publication of the offer along with its conditions and the opening of the offer, making it possible for the persons to subscribe to it.

More precisely, as already anticipated, this publication can take place in a website or in an internet platform in which the method of the invention is applied.

The preferred embodiment of the invention includes the publication, along with the conditions of the offer, of a short description of the product and/or service in sale and an image or picture of it.

Furthermore, the preferred embodiment of the invention includes the publication of the starting price, said starting price being preferably but not necessarily equal to the normal market price related to the product and/or service on sale.

Furthermore, the preferred embodiment of the invention includes the publication of the prearranged discounted price of the product and/or service on sale, indicated in absolute value or as a percentage of the starting price of the above-mentioned product and/or service.

Furthermore, the preferred embodiment of the invention includes the publication of the prearranged minimum number of buyers required to make the sale at the prearranged discounted price valid and, once the offer has been opened, the number of persons who have subscribed to the offer is updated at any new subscription.

The following step 8 of the method of the invention includes the collection by the owner and/or the manager of the website or platform in which the method of the invention is applied of the subscriptions made by the persons interested in the offer. More precisely, the subscription requires that each of the above-mentioned persons pays the full amount of the prearranged discounted price before he/she can effectively be considered a buyer of the offer by the owner and/or the manager of the website or platform in which the method of the invention is applied.

When a person subscribes to the offer, and for the whole period of time during which it remains open, preferably but not necessarily he/she has the option of inviting other users and persons to subscribe to the offer.

The method of the invention can also include the fact that any person being aware of the offer has the option of inviting other persons or users to subscribe to it, even if he/she did not subscribe to said offer.

In this way, advantageously, the buyer has the opportunity to act directly in order to make the offer reach the prearranged minimum number of buyers as soon as possible, which will make the sale of the above-mentioned product and/or service at the prearranged discounted price valid.

Such invitations can take place through social-networking services and platforms, or through different kinds of technological and non-technological instruments such as word-of-mouth advertising.

Obviously, the subscription included in the above-mentioned step 8 is possible from the opening of the offer until its closing, due to either the reaching of the prearranged number of buyers or the expiry of the prearranged maximum amount of time.

In fact, if the prearranged minimum number of buyers is reached before the above-mentioned maximum amount of time has expired, the method of the invention includes the closing of the offer in advance, followed by the operations of conclusion of the sale, in ways that will be explained later.

As stated before, the number of persons who subscribed to the offer is continuously updated and published along with the offer in the related internet website's page, as it is indicated in step 9 of the method of the invention illustrated in FIG. 1.

In this way, advantageously, the persons interested in the offer are fully aware of its progress and can consequently act directly to make the offer reach the prearranged minimum number of buyers as soon as possible, which will make the sale of the above-mentioned product and/or service at the prearranged discounted price valid.

Furthermore, every time that a person subscribes to the offer, the method of the invention includes checking, in step 10, if the prearranged minimum number of buyers has been reached before the expiring of the prearranged maximum amount of time. If the case occurs, as it has been said before, the method of the invention includes the closing of the offer in advance.

Such verification is obviously performed also at the expiring of the prearranged maximum amount of time, as indicated in the same step 10 in combination with step 11 in the flowchart 1.

After such verification, the persons who subscribed to the offer are informed about its outcome, that is, whether the prearranged minimum number of buyers has been reached or not.

In the first case, the following step 12 of the method of the invention includes the closing of the sale of the above-mentioned product or service through the delivery of the same product to the persons who subscribed to the offer—possibly but not necessarily, after the payment of a delivery fee—or the free delivery of a proof of purchase—possibly but not necessarily, a coupon—which will allow the persons who subscribed to the offer to obtain the above-mentioned product or service in a shop or directly from the vendor.

On the contrary, if the prearranged minimum number of buyers is not reached, each of the persons who subscribed to the offer will have the opportunity to pick and execute one of two options before the expiry of a prearranged amount of time, as described in step 13.

The first option 131 allows the person to purchase the above-mentioned product or service paying a certain extra-amount before the expiry of a prearranged amount of time. The method of the invention preferably but not necessarily includes that such extra-amount is proportional to the number of persons who actually subscribed to the offer.

More precisely, the preferred embodiment of the method of the invention includes that such extra-amount is calculated as follows.

The first step is to subtract the prearranged discounted price from the starting price, in order to obtain the full amount of the saving offered by the above-mentioned offer if the prearranged minimum number of buyers is reached. Obviously, such subtraction is not performed if the full amount of the saving is already known.

The second step is to divide such saving by the prearranged minimum amount of buyers, in order to obtain the unit saving for each potential buyer.

The third step is to multiply such unit saving by the number of persons who subscribed to the offer, in order to obtain the full amount of the actual saving obtained at the end of the offer.

The fourth step is to subtract the full amount of the actual saving from the starting price of the above-mentioned product and/or service, in order to obtain the actual discounted price reached at the end of the offer.

The last step is to subtract the prearranged discounted price—which has already been paid by the persons who subscribed to the offer—from the actual discounted price reached at the end of the offer, in order to obtain the above-mentioned extra-amount to be paid in order to purchase the above-mentioned product and/or service if the prearranged minimum number of buyers is not reached.

Nevertheless, the method of the invention could include an alternative calculation of the extra-amount to be paid in order to purchase the above-mentioned product and/or service even if the prearranged minimum number of buyers is not reached.

More precisely, the method of the invention could include the setting, before the opening of the offer, of at least one intermediate price between the normal market price and the prearranged discounted price.

Such intermediate price is associated with an intermediate number of buyers that is smaller than the prearranged minimum number of buyers.

In this way, if the number of persons who subscribed to the offer is included between the prearranged minimum number of buyers and the intermediate number of buyers related to the intermediate price, the extra-amount to be paid in order to purchase the above-mentioned product and/or service will be equal to the difference between the intermediate price and the prearranged discounted price.

On the contrary, if the number of persons who subscribed to the offer is smaller than the intermediate number of buyers, they will be allowed to purchase the above-mentioned product and/or service only at the starting price. Thus, in the above-mentioned case, the extra-amount to be paid would be equal to the difference between the starting price and the prearranged discounted price already paid by the users who subscribed to the offer.

Obviously, such a procedure makes sense only if a certain amount of intermediate prices are set, each one to be related to a certain intermediate number of buyers, such intermediate numbers of buyers being inversely proportional to their related intermediate price.

Obviously, the above-mentioned intermediate numbers of buyers have to be smaller than the prearranged minimum number of buyers.

In this case, the extra-amount to be paid in order to purchase the above-mentioned product and/or service is equal to the difference between one of the intermediate prices and the prearranged discounted price, where the intermediate price selected is the one that is associated to the intermediate number of buyers that, among those previously defined, is immediately higher than the actual number of users who subscribed to the offer.

Alternatively to the first option 131—which has been described so far—, as stated before, the persons who subscribed to the offer that did not reach the prearranged minimum amount of buyers can pick and execute the second option 132.

The second option allows the above-mentioned persons who subscribed to the offer to ask, before the expiry of a prearranged amount of time, for the prearranged refund. As stated before, this refund is preferably but not necessarily given as a credit to be used at any time on any other open offer that is or will be present on the website or platform that applies the method of the invention.

More precisely, the preferred embodiment of the invention includes that the full amount of the refund be equal to a percentage of the prearranged discounted price which has already been paid by the users who subscribed to the offer. Preferably but not necessarily, such percentage is included between 80% and 99%; typically the chosen percentage is 90%.

The prearranged amount of time within which the person who subscribed to an offer which did not reach the prearranged minimum number of buyers has to pick and execute one of the above-mentioned options is preferably but not necessarily three days.

A second embodiment of the method of the invention, alternatively, can include the fact that the users interested in the offer, instead of paying the full amount of the prearranged discounted price, can subscribe to said offer by paying a percentage of the starting price. Said percentage would obviously result in a smaller monetary value than the prearranged discounted price. In this case, if the offer is successful and reaches the prearranged minimum number of buyers, the persons who subscribed to the offer will have a prearranged amount of time to pay the difference between the prearranged discounted price and the percentage of the starting price that they already paid in order to purchase the product and/or the service related to the offer. On the contrary, if the offer is not successful and does not reach the prearranged minimum number of buyers, the persons who subscribed to the offer will have a prearranged amount of time to purchase the product and/or service by paying the difference between the actual discounted price reached at the end of the offer and the percentage of the starting price that they already paid. If, at the expiry of the prearranged amount of time, a person who subscribed to the offer does not pay said difference, the percentage of the starting price that he paid will be owned by the owner and/or the manager of the website or platform in which the method is applied, and the user will not be entitled to ask for any refund.

An example of application of the first embodiment of the method is presented here: an offer of sale of a LCD monitor through the use of the method of the invention.

A XYZ vendor proposes his/her offer to the owner and/or the manager of the website or platform in which the method is applied. The owner and/or manager elaborates the offer conditions and decides to approve the publishing of the above-mentioned offer on the website or platform. The XYZ vendor provides information about the product, that is, the LCD monitor, including a starting price.

The starting price of the offer is set to be equal to the normal market price, that is 100 dollars.

The minimum number of buyers is set at 200 buyers. If such a number of buyers is reached, each LCD monitor will be sold to each of the 200 buyers at 50 dollars, that is, with a 50% discount on the normal market price. If the prearranged minimum number of buyers is not reached, the refund offered to the potential buyers is equal to 90% of the prearranged discounted price, that is, 45 dollars.

Furthermore, the maximum amount of time during which the offer will be open is set at 48 hours.

Once such conditions have been agreed upon and published, the offer is open preferably but not necessarily in a related internet page inside the above-mentioned website or platform.

More precisely, in the above-mentioned page a technical description and a picture and/or image of the LCD monitor are published.

The starting price, the prearranged discounted price, the countdown to the expiry of the offer and the continuously updated number of persons who subscribed to the offer are also published.

The persons starting price of the offer is set to be equal to the normal market price, that is 100 dollars interested in the offer have the opportunity to subscribe to it until the expiry of the prearranged maximum amount of time, or until the number of persons who subscribed to the offer reaches the prearranged minimum amount of buyers before the expiry of the offer.

As stated before, each person who would like to subscribe to the offer has to pay the prearranged discounted price, which in this case is equal to 50 dollars.

If the prearranged minimum number of buyers—in this case, 200 buyers—is reached before the expiry of the offer, the offer is dosed and the sale is concluded with the delivery of the above-mentioned LCD monitor to each person who subscribed to the offer, possibly after the payment of a delivery fee.

Alternatively, said persons can receive a free electronic proof of purchase—for instance, a coupon—which will be valid to obtain the LCD monitor from a shop or directly from the vendor.

On the contrary, if at the expiry of the prearranged maximum amount of time just 150 persons have subscribed to the offer and the prearranged minimum number of buyers—which in this case is equal to 200 buyers—has not been reached, each of the above-mentioned 150 persons has the opportunity to pick and execute one of the two above-described options.

More precisely, the first option allows each person who subscribed to the offer to purchase the LCD monitor paying an extra-amount that is calculated as follows.

Firstly, the 50-dollar saving—which is equal to the difference between the starting price and the prearranged discounted price—has to be divided by the prearranged minimum number of buyers, that in this case is equal to 200.

Thus, the operation is: 50/200=0.25. The result—0.25 or 25 dollar-cents—is the value of the unit saving for each potential buyer.

In order to calculate the actual saving reached, the unit saving of 0.25 has to be multiplied by the number of persons who subscribed to the offer, in this case 150. Thus, the operation is: 0.25×150=37.5 dollars.

Thus, the actual price of the LCD monitor at the expiry of the offer is obtained by subtracting the actual saving reached by the offer—in this case, 37.5 dollars—from the starting price—in this case, 100 dollars. Thus, the operation is: 100−37.5=62.5 dollars.

Since the persons who subscribed to the offer have already paid the prearranged discounted price—in this case, 50 dollars—the extra-amount to be paid to purchase the LCD monitor is obtained by subtracting the prearranged discounted price from the actual price of the LCD monitor at the expiry of the offer—in this case, 62.5 dollars. Thus, the operation is: 62.5−50=12.5 dollars.

The second option allows the persons who subscribed to the offer to freely get the prearranged refund, which is set to be equal to 90% of the prearranged discounted price. Thus, the operation is: (50/100)×90=45 dollars.

Preferably but not necessarily, this refund can be given as a credit to be used at any time for any other open offer that is or will be present on the website or platform that applies the method of the invention.

The implementation and the application of the method of the invention preferably include the use of a network service or of a computer infrastructure. The method of the invention is also implemented and applied through the use of a software stored in a computer memory and executed by one or more microprocessors, both related to the above-mentioned network server or to the above-mentioned computer infrastructure.

The word “software” means for instance algorithms, programs, instructions, signals and/or data that can be used in order to execute the method of the invention for the offer and the sale of products and/or services at a discounted price.

The invention is meant to be related to a computer program product suited to be directly uploaded into the computer memory of the above-mentioned network server or computer infrastructure, and including the above-mentioned software configured in order to implement the method of the invention.

The described embodiments are to be considered in all respects only as illustrative and not restrictive, and the scope of the invention is, therefore, indicated by the appended claims rather than by the foregoing description. Any person skilled in the art will recognize changes, substitutions and other modifications that nonetheless come within the scope of the invention and of the claims.

1. Method for the offer and sale of one or more products and/or services by a vendor to groups of persons, said method being implemented by means of a network server or a computer infrastructure including one or more microprocessors, a computer memory and a software, said software being uploaded in said computer memory and executed by said microprocessor, said software including also an algorithm for the offer and sale of said one or more products and/or services, wherein said algorithm includes the following steps:
approving said offer made by said vendor of a product and/or service having a starting price and allowing said vendor to publish said offer;
identifying said product and/or said service and setting said discounted price in relation to said starting price and associating said discounted price with said product and/or said service;
setting the minimum number of buyers of said product and/or said service that must be reached so that the sale at said discounted price can be considered valid;
setting the maximum amount of time of the duration of said offer of said product and/or said service;
setting the amount of the refund to be proposed to the persons who subscribed to said offer if said minimum number of buyers is not reached within said maximum amount of time;
publishing the conditions of said offer and starting said sale;
collecting the subscriptions to said offer of sale by interested persons, each one of said subscriptions being accepted upon payment of said discounted price or of a percentage of said starting price by said persons;
publishing the updated number of said persons who subscribed to said offer;
determining if the minimum number of buyers has been reached within said maximum amount of time;
informing said persons who subscribed to said offer about whether said minimum number of buyers has been reached or not;
in the case where said minimum number of buyers has been reached within said maximum amount of time, concluding the sale of said product and/or said service by delivering said product or a coupon related to said product or to said service to each one of said persons who subscribed to said offer;
in the case where said minimum number of buyers has not been reached within said maximum amount of time, allowing each one of said persons who subscribed to said offer to choose and execute one of the following options:
a) paying, within a prearranged amount of time, an additional amount of money proportional to the number of said persons who subscribed to said offer, so as to be able to purchase said product and/or said service;
b) requesting, within said prearranged amount of time, the reimbursement of an amount corresponding to said refund.

2. Method according to claim 1, wherein following the subscription of said offer by each one of said persons and until the expiry of said maximum amount of time, said persons have the possibility to invite other persons to subscribe to said offer.

3. Method according to claim 1), wherein if said minimum number of buyers is reached before the expiry of said maximum amount of time, said offer is closed in advance and said sale is concluded with the delivery of said product or said coupon related to said product or to said service to each of the persons who subscribed to said offer.

4. Method according to claim 1), wherein said refund is given as a credit to be used at any time on any other offer that is or will be published and opened in said website or platform through which said method of sale is implemented.

5. Method according to claim 1), wherein the value of said percentage of the starting price to be paid on subscription of said offer is lower than said prearranged discounted price.

6. Method according to claim 1), wherein in the case where said minimum number of buyers is reached within said maximum amount of time the difference between said discounted price and said value of said percentage of the starting price must be paid within a prearranged amount of time.

7. Method according to claim 1), wherein said additional amount of money to be paid in order to be able to purchase said product and/or said service even if said minimum number of buyers is not reached within said maximum amount of time is calculated through the following operations to be executed in sequence:
subtracting said discounted price from said starting price in order to obtain the amount of saving offered through said offer of sale;
dividing said saving by said minimum number of buyers, in order to obtain the unit saving for each one of said buyers;
multiplying said unit saving by the number of said persons who subscribed to the offer, in order to obtain the actual amount of saving reached at the expiry of said offer;
subtracting said actual amount of saving reached from said starting price of said product or said service, in order to obtain the actual discounted price reached at the expiry of said maximum amount of time;
subtracting said discounted price set at the opening of said offer or said percentage of the starting price paid on subscription from said actual discounted price, in order to obtain the value of said additional amount of money.

8. Method according to claim 1), wherein before the beginning of said offer of sale at least one intermediate price included between said starting price and said discounted price is set, said intermediate price being associated to an intermediate number of buyers that is smaller than said minimum number of buyers, and wherein said additional amount of money to be paid in order to be able to buy said product and/or said service even if said minimum number of buyers is not reached corresponds to the difference between said intermediate price and said discounted price or to said percentage of said starting price paid, if the number of said persons who subscribed to said offer is included between said minimum number of buyers and said intermediate number of buyers related to said intermediate price.

9. Method according to claim 8, wherein, before the opening of said offer of sale, a plurality of said intermediate prices included between said starting price and said discounted price is set, each of said intermediate prices being associated to an intermediate number of buyers that is inversely proportional to the corresponding value of the intermediate price and lower than said minimum number of buyers, and wherein said additional amount of money to be paid in order to be able to purchase said product and/or said service even if said minimum number of buyers is not reached corresponds to the difference between one of said plurality of intermediate prices and said discounted price or to said percentage of said starting price paid, said intermediate price chosen being the intermediate price related to the intermediate number of buyers that is immediately higher than the actual number of said persons who subscribed to the offer.

10. Method according to claim 1), wherein said value of said refund corresponds to a percentage value of said discounted price paid on subscription of said offer of sale.

11. Method according to claim 10, wherein said percentage is included between 80% and 99%.

12. Method according to claim 11, wherein said percentage is 90%.

13. Method according to claim 1), wherein said prearranged amount of time set for requesting said refund or concluding the purchase if said minimum number of buyers has not been reached is three days.

14. Method according to claim 1), wherein said discounted price is reduced by a fixed amount with respect to said starting price.

15. Method according to claim 1), wherein said discounted price is reduced by a percentage value with respect to said starting price.

16. Method according to claim 1), wherein said publication of said conditions of sale includes the description of said product and/or said service.

17. Method according to claim 1), wherein said publication of said conditions of sale includes an image of said product and/or said service.

18. Method according to claim 1), wherein said starting price of the offer is set to be equal to the normal market price of said product and/or said service.
